(19) United States
(12) Patent Application Publication
(10) Pub. No.: US 2003/0221702 A1
(43) Pub. Date: Dec. 4, 2003

(54) Process for cleaning and repassivating semiconductor equipment parts

(76) Inventor: Henry C. Peebles, Albuquerque, NM (US)

Correspondence Address: ATMI, INC., 7 COMMERCE DRIVE, DANBURY, CT, 06810, US

(21) Appl. No.: 10/156,204

(22) Filed: May 28, 2002

(51) Int. Cl. B08B 7/04

(52) U.S. Cl. 134/1; 134/3; 134/41; 134/6; 134/28

(57) ABSTRACT

A wet cleaning/passivation process for a passivatable metal part including a contaminant-bearing surface. The process includes the steps of: (a) contacting the contaminant-bearing part with an aqueous acid solution effective for pickling the contaminant-bearing surface of the contaminant-bearing part, with such contacting being conducted for sufficient time and at sufficient temperature to achieve pickling of the contaminant-bearing surface; (b) contacting the cleaned surface of the part with a passivating aqueous solution, with such contacting being conducted for sufficient time and at sufficient temperature to passivate the cleaned surface; and (c) CO₂ blasting the surface, to remove micron and sub-micron particles from the surface.

### CROSS-REFERENCE TO RELATED APPLICATION

The priority of U.S. Provisional Application No. 60/293,690 filed May 24, 2002 is hereby expressly claimed.

### BACKGROUND OF THE INVENTION

1. Field of the Invention

The present invention relates generally to processes for cleaning parts, and more particularly, the invention relates to a system and method for process for cleaning and repassivating semiconductor equipment parts that significantly reduces particles generated from surfaces of these parts.

2. Description of the Related Art

In the field of semiconductor manufacturing, the repetitive use of process equipment creates a corresponding need for cleaning and repassivating surfaces of the equipment, to renew them for renewal of processing capability.

Cleaning and repassivating methods in current use include the bead blast and Scotchbrite processes. These processes, however, produce particulate residues, e.g., of aluminum oxide particles, on the surfaces that have been cleaned. In consequence, the residues remaining on the surfaces of the process equipment persist into the renewed onstream processing operations and are a source of contamination of the semiconductor wafers and device structures fabricated thereon. Such contamination may render the finished wafer product unsatisfactory or even useless for its intended end use, and necessitate reworking or even discarding of the wafer, thereby severely impacting the process economics and industrial viability of the manufacturing facility.

High chrome stainless steels are used as a material of construction for a wide variety of parts and components of the semiconductor manufacturing equipment in a typical “fab.” The ubiquity of such material of construction is a result of its passivated character, in which a surface layer of chromium oxide deriving from the presence of Cr in the steel passivates the underlying steel, and produces inert, stable surfaces that are resistant to attack, e.g., by oxidative and other corrosive agents that are brought into contact with the wafer and correspondingly with the surfaces of the process equipment, flow circuitry and other portions of the fab infrastructure.

The cleaning and reconditioning process involving stainless steel surfaces therefore desirably removes any contaminants and residues resulting from the preceding active processing, and restores the chromium oxide passivation layer to any surfaces from which it has been removed in active processing and any preceding cleaning steps.

By efficient cleaning, corrosion products and other contaminants are removed from the surfaces of the process system equipment, parts and components. By efficient repassivation, the protective inert surface layer is restored to such surfaces, to inhibit corrosion and chemical attack during subsequent wafer processing and semiconductor product manufacture.

The prior art approaches are deficient in achieving the levels of cleaning and repassivation that produce desired high yields of wafer products (e.g., treated wafers, microelectronic device structures, integrated circuits, etc.) with near-zero rejects in sustained cyclic operation of the semiconductor manufacturing facility.

### SUMMARY OF THE INVENTION

The present invention relates generally to cleaning processes, and more particularly, the invention relates to a system and method for cleaning and repassivating semiconductor equipment parts that significantly reduce particles generated from surfaces of these parts.

The present invention in one aspect relates to a wet cleaning/passivation process for a passivatable part including a contaminant-bearing surface, in which the process includes the steps of: (a) contacting the contaminant-bearing part with an aqueous acid solution effective for pickling the contaminant-bearing surface of the contaminant-bearing part, with such contacting being conducted for sufficient time and at sufficient temperature to achieve pickling of the contaminant-bearing surface; (b) contacting the cleaned surface of the part with a passivating aqueous solution, with such contacting being conducted for sufficient time and at sufficient temperature to passivate the cleaned surface; and (c) CO₂ blasting the surface, to remove contaminant material from the surface.

Another aspect of the invention relates to a process for cleaning and passivating a non-bellows stainless steel part, comprising the steps of:

(a) pickling the part in an aqueous pickling solution containing HF and HNO₃;

(b) soaking the part in a deionized water rinse bath;

(c) passivating the part by contacting it with an aqueous passivating solution;

(d) resoaking the part in a deionized water rinse bath;

(e) drying the part;

(f) CO₂ snow blasting the part.

A still further aspect of the invention relates to a process for cleaning and passivating a semiconductor process tool bellows assembly including a bowl having an O-ring groove therein and an opposing flange to said bowl, said process comprising the steps of:

(a) polishing the O-ring groove on the bowl of the bellows, the outside of the bowl and the opposing flange at an outside edge thereof;

(b) pickling the bellows in an aqueous pickling solution including HF and HNO₃;

(c) rinsing the bellows in a deionized water bath;

(d) passivating the bellows in an aqueous passivating solution;

(e) rinsing the bellows in a deionized water bath; and

(f) CO₂ snow blasting the bellows.

In another aspect, the invention relates to a process of removing bead blasting residue from a stainless steel surface comprising same, said process comprising contacting the stainless steel surface comprising the bead blasting residue thereon with an aqueous pickling solution comprising hydrogen fluoride and nitric acid, in sufficient concentrations relative to each other to effect pickling removal of bead blasting residue from the surface, whereby the bead blasting residue on the surface is at least partially reduced by said contacting.

In yet another aspect, the invention relates to a method of increasing the operating life of a semiconductor processing tool between successive maintenance events, in which the semiconductor manufacturing tool comprises a stainless steel surface which during the operating life are contaminated with contaminant species deriving from a semiconductor process conducted by the semiconductor processing tool and/or ambient exposure to an ambient environment of the semiconductor processing tool, said method comprising conducting said maintenance events to include cleaning and passivation of the stainless steel surface initially presented as a contaminant-bearing surface, by steps including:

(a) contacting the surface with an aqueous acid solution effective for pickling the contaminant-bearing surface, with such contacting being conducted for sufficient time and at sufficient temperature to achieve pickling of the contaminant-bearing surface and produce a corresponding cleaned surface;

(b) contacting the cleaned surface with a passivating aqueous solution, with such contacting being conducted for sufficient time and at sufficient temperature to passivate the cleaned surface; and

(c) CO₂ blasting the surface, to remove contaminant material from the surface.

Another aspect of the invention relates to a method of determining amenability of a stainless steel surface of a semiconductor manufacturing tool to wet cleaning and passivation treatment, wherein the wet cleaning and passivation treatment includes exposure of the stainless steel surface to an aqueous acid solution, said method comprising contacting the surface with an aqueous acid solution of at least the same strength as that involved in said wet cleaning and passivation treatment, and determining whether insoluble powder is released from the surface into the aqueous acid solution, evidencing intergranular corrosive attack of the surface, and contraindicating the surface as amenable to said wet cleaning and passivation treatment.

Still another aspect of the invention relates to a method of controlling contamination of semiconductor processing tool parts forming a component assembly of a semiconductor processing tool, prior to incorporation of the parts into a tool in a semiconductor processing facility, said method comprising the steps of: (a) CO₂ snow blasting of the parts; (b) assembling the parts upon completion of step (a), in a clean room environment; (c) CO₂ snow blasting the assembly to remove any accumulated chemical contamination and particle matter; (d) vacuum baking the assembly in the clean room environment; (e) securing the assembly to a fixture member in an evacuated hard container; (f) packaging the assembly with a getter; and (g) installing the assembly in the tool in the semiconductor processing facility upon removal of the assembly from the evacuated hard container.

A further aspect of the invention relates to a process of operating a semiconductor processing facility wherein parts comprising stainless steel surfaces are periodically cleaned to renew the parts for reuse in the facility, and cleaning includes treatment that increases surface roughness, wherein the process comprises (a) marking each part with identification indicia, (b) tracking surface roughness and number of cleaning cycles with reference to said identification indicia to determine when the parts have reached or will reach a predetermined maximum roughness limit, and (c) polishing surfaces of the parts before their surfaces exceed the predetermined maximum roughness limit, to restore lower roughness to such surfaces, for reuse of the parts in said semiconductor processing facility.

Other aspects, features and advantages of the invention will be more fully apparent from the ensuing disclosure and appended claims.

### BRIEF DESCRIPTION OF THE DRAWINGS

FIGS. 1A and 1B show the “patterned” surface finish and uniform surface finish, respectively, obtained on BBSH parts cleaned using the process of the present invention.

FIG. 2A depicts that the exposed welds on the parts exhibited a thin black surface discoloration after pickling and FIG. 2B is a corresponding view after CO₂ snow blasting.

FIG. 3A shows abrasion sites on a GV1 outer shield heat affected zone.

FIG. 3B shows abrasion sites on the inside surface of a nylon bag.

FIGS. 4A and 4B show scratch damage to a part's sealing surfaces, including a GV1 bottom flange (FIG. 4A) and a GV1 top flange (FIG. 4B).

FIGS. 5A, 5B and 5C depict cracks located within spot welds on GV1 inner shields.

### DETAILED DESCRIPTION OF THE INVENTION, AND PREFERRED EMBODIMENTS THEREOF

The disclosure of U.S. Provisional Application No. 60/293,690 filed May 24, 2001 is hereby incorporated herein by reference in its entirety.

The wet cleaning/passivating process of the invention provides effective treatment of contaminant-bearing stainless steel surfaces, to remove such contaminants, e.g., embedded particles deriving from prior bead blasting cleaning of the surface, as well as process-related contaminants such as reagent residues, and degradation and reaction byproducts of reagents used in the active processing carried out in the process system comprising the parts that subsequently present the contaminant-bearing stainless steel surfaces.

In one aspect, the wet cleaning/passivation process includes the steps of: contacting the contaminant-bearing part with an aqueous acid solution containing pickling acids, for example hydrofluoric acid and nitric acid, in amounts effective for pickling the contaminant-bearing surface of the contaminant-bearing part, with such contacting being conducted for sufficient time and at sufficient temperature to achieve pickling of the contaminant-bearing surface (pickling here referring to the at least partial removal of contaminant from the contaminant-bearing surface, e.g., the partial or preferably complete removal of scale, oxides and particles from the surface); rinsing in deionized water, such rinsing being effective to remove any fluoride ion that may be present on the surface resulting from the pickling step; contacting the cleaned surface of the part with a passivating aqueous solution of acid, as for example nitric acid, with such contacting being conducted for sufficient time and at sufficient temperature to passivate the cleaned surface (passivation here referring to the chemical treatment of the surface to form a chemically inactive surface with enhanced resistance to corrosion); rinsing the cleaned and passivated surface with deionized water to remove ionic residues and particle matter, optionally with ultrasonic cleaning to ensure clean-out of deep crevices in weld joints and blind holes in the part being treated; drying the part; and CO₂ blasting the surface, e.g., by CO₂ ice blasting, or more preferably by CO₂ snow blasting, to remove micron and sub-micron particles from the surface. The CO₂ blasting in the process can include both types, i.e., of ice blasting and snow blasting, and the process may include multiple CO₂ blasting steps of one or both types. The CO₂ blasting may be carried out at any suitable point in the process, e.g., prior to and/or after the pickling and/or passivation steps, as appropriate to the cleaning required and condition of the surface that is needed in subsequent use when the reconditioned part is returned to active processing service. The passivation step, however, will take place subsequent to the pickling step, and not before pickling is carried out, it being understood that consistent with the foregoing that CO₂ blasting and/or other processing steps, e.g., rinsing, drying, etc., may be carried out between the pickling and the passivation steps of the process.

In the wet cleaning process, the pickling solution may for example comprise an aqueous solution of hydrofluoric and nitric acids, in which the hydrofluoric acid may for example be present in a concentration of 1% by weight, based on the total weight of the solution, and the nitric acid may for example be present in a concentration of 7% by weight, on the same total weight basis. The amount of HF may in general vary from about 0.2% to about 5% by weight, based on the total weight of the solution, and the nitric acid may in general vary from about 5% to about 20% by weight, on the same total weight basis. Preferred weight ratios of HNO₃:HF in the pickling solution are in a range of from 1 to about 100, and most preferably from about 5 to about 20.

The conditions of the pickling solution contacting with the contaminant-bearing surface may be widely varied in the general practice of the invention. For example, the temperature of the pickling solution in such contacting step, in one preferred embodiment of the invention, is in a range of from about 25° C. to about 80° C., more preferably from about 30° C. to about 75° C., and most preferably from about 35° C. to about 65° C. The contacting time in the pickling step may likewise be varied, with the temperature required for a given pickling application being inversely related to the contacting time involved, as well as being functionally related to the type and concentration of the acids in the pickling solution, and the nature and extent of the contamination of the surface to be cleaned.

Contaminants in the broad practice of the invention include, without limitation, free iron, oxide scale, rust, grease, oil, carbonaceous or other residual chemical films, soil, particles, metal chips, dirt and any other nonvolatile deposits that can adversely affect the metallurgical or sanitary condition or stability of a surface.

In a specific embodiment, the pickling step is carried out with a pickling solution containing 1% HF and 7% HNO₃, at a temperature of 53° C. for a contacting time of 10 to 60 minutes.

In like manner, the passivation step of the wet process may be varied widely in the broad practice of the present invention. The passivation solution contains a passivating agent, in sufficient concentration to effect passivation of the cleaned surface subsequent to pickling thereof. The passivating agent may comprise nitric acid, citric acid, an organosulfonic acid, hydrides of silicon, germanium, tin or lead, potassium hydroxide, sodium hydroxide, copper sulfate, sodium chromate, and mixtures of two or more species thereof, with nitric acid generally being most preferred.

The passivating agent may be employed in any suitable concentration, having reference to the specific contacting conditions and the nature of the surface to be passivated. For the most preferred passivating species, nitric acid, the concentration of nitric acid in an aqueous passivating solution is preferably in a range of from about 15% to about 50% by weight, based on the total weight of the passivating solution, more preferably from about 20% to about 40% by weight, and most preferably from about 25% to about 30%, on the same total weight basis.

The conditions of the passivating solution contacting with the cleaned surface may be widely varied in the general practice of the invention. For example, the temperature of the passivating solution in such contacting step, in one preferred embodiment of the invention, is in a range of from about 25° C. to about 80° C., more preferably from about 30° C. to about 75° C., and most preferably from about 35° C. to about 65° C. The contacting time in the passivating step may likewise be varied, with the temperature required for a given passivation application being inversely related to the contacting time involved, as well as being functionally related to the type and concentration of the passivating agent in the passivating solution, and the nature and morphology of the surface to be passivated. In specific applications of the process of the invention, the passivating step may involve contacting with the passivating solution for a time on the order of from about 15 minutes to about 2 hours, depending on the passivating agent, its concentration in the passivating solution, the nature of the substrate material, and the degree of passivation required.

In a specific embodiment, the passivation step is carried out with a passivating solution containing 28% HNO₃ by weight, based on the total weight of the passivating solution, at a temperature of 53° C. for a contacting time of 30 minutes.

The drying of the passivated surface in the method of the invention may be carried out in any suitable manner, including air drying, alcohol drying (involving application to the surface of the alcohol drying agent, and drying (evaporation) of the alcohol), oven baking of the substrate article including such surface.

By way of illustrative example, the method of the invention may be carried out with baking of the substrate article for 1 hour in air (oven ambient), optionally after air and/or alcohol drying at ambient temperature (e.g., ˜25° C.).

The substrate to which the process of the invention is applied may be of any suitable metal, ceramic, cermet or like material of construction. The invention has particular utility to the wet cleaning and passivation of stainless steel articles, such as parts used in processing equipment for the manufacture of semiconductor products. Such parts in one illustrative embodiment include semiconductor process tool parts, particularly those that are exposed to fab environments (ambient atmosphere in a semiconductor manufacturing plant) or process streams in manufacturing operations in the semiconductor manufacturing plant.

The CO₂ snow-blasting step in the process of the invention may be carried out with CO₂ snow generation using a snow-generating apparatus such as the Snow Gun-II Cleaner CO2 Snow Gun, commercially available from Vatran Systems, Inc. (Chula Vista, Calif.). CO₂ snow-blasting involves directing a stream of small flakes of dry ice (e.g., generated by expanding liquid CO₂ to atmospheric pressure through a nozzle, thereby forming soft flakes of CO₂) at the surface being treated, so that the flakes hit small particulate contaminants less than one micron in size on the substrate, then vaporize via sublimation, lifting the contaminants from the surface. The contaminants and the CO₂ gas then typically are passed through a filter, such as a high efficiency particulate air (HEPA) filter, where the contaminants are collected and the gas is released.

The process of the invention completely removes bead blast media that is embedded in the surface of the steel to be cleaned, e.g., from prior bead blast cleaning of the surface, as well as completely removing metal flakes and corrosion debris from the surface. The process completely removes heavy buildup of aluminum oxide (Al₂O₃) contamination on bellows leaves of semiconductor tools including bellows assemblies, and effectively cleans out weld joint crevices in such bellows assemblies. The process repassivates stainless steel, to inhibit further corrosion when the substrate article including the cleaned and passivated surface is placed in service.

By providing an effective alternative to bead blasting and Scotchbrite® cleaning techniques, the deleterious exposure of the substrate article surface to abrasive and contaminating media is avoided. Further, by using CO₂ snow blasting rather than CO₂ ice blasting, small metal particles are more effectively removed from the surface being treated, and the resulting treated surface is more residue-free in character than would be the case if CO₂ ice blasting were used in the process of the invention. Finally, the process of the invention achieves substantially less surface erosion than current bead blasting cleaning processes.

The process of the present invention has been demonstrated to completely remove refractory aluminum oxide and silicon dioxide contaminant films from the surface of 300-series stainless steels with minimum erosion of the steel substrate, and to effectively remove such contamination from deep recesses and crevices in the part. The process removes corrosion from the surface of the steel and re-establishes the chromium oxide passivation layer, as well as removing bead blast media embedded in the surface of the steel, to produce a cleaned and passivated surface free of flakes and other particle precursors.

The present invention provides a pickle and passivation wet cleaning process that is usefully applied to semiconductor reactor parts for removal of oxides and corrosion/degradation/reaction products, and repassivation of surfaces to inhibit further corrosion. The cleaning process of the invention produces substantially improved wafer yields, relative to conventional cleaning techniques.

The cleaning process of the invention may be readily applied in various forms to the cleaning of semiconductor manufacturing equipment parts, and to a number of metal and ceramic substrate articles having contaminants on their surfaces, in which the contaminants are susceptible to removal by processing steps as described herein. A particularly preferred application for the process of the invention is the removal of residues formed on the internal surfaces of semiconductor processing tools during patterned etching of aluminum metal from the surface of silicon wafers. The refractory components in this residue are Al₂O₃ and oxyfluoride analogs.

The features and advantages of the invention are more fully shown by the following non-limiting examples.

### EXAMPLE 1

Stainless steel components from a Hitachi M308 tool, excluding (GV-1, GV-2 and ER) bellows components, were cleaned by the process steps set out below.

Cleaning and Passivation Process

1. The parts were pickled in a seasoned aqueous bath containing 1.1 wt. % HF and 9.5 wt. % HNO₃, at 53° C. for exactly 10 minutes. The pickling process was immediately terminated and the part was quenched in a deionized water bath, if excessive evolution of bubbles from the part was observed during immersion in the acid bath.

2. The part next was soaked in a first DI water rinse bath for 10 minutes, inspected while wet, and then wiped clean of any remaining residue on its surfaces, using a clean DI water-soaked polyester cloth.

3. Following step 2, the part was passivated in a 34.0 wt. % HNO₃ bath at 53° C. for 30 minutes. The passivation process was immediately terminated and the part was quenched in a deionized water bath, if excessive evolution of bubbles from the part was observed during immersion in the acid bath.

4. The passivated part then was soaked in the first DI water rinse bath for 10 minutes, inspected while wet, and then wiped clean of any apparent surface stains, using a clean DI water-soaked polyester cloth.

5. Following step 4, the part was soaked in a second DI water rinse bath for 30 minutes. The soaking may be carried out under ultrasonic conditions.

6. Next, the part was soaked in a third DI water rinse bath for 30 minutes.

7. The part then was dried, by air drying or IPA drying. The dried part is inspected, and any apparent surface stains are removed, using a clean IPA-soaked polyester cloth.

8. The part thereupon was further dried in a forced air oven at 110° C. for 60 minutes.

9. The part was cooled to room temperature.

10. The part was CO₂ snow blasted thoroughly in a Class 100 clean room environment, paying particular attention to screw holes, particle trap points and weld beads. Weld beads changed from a dark to a lighter color, more closely matching the rest of the part.

11. The part was inspected for stained surfaces or any residue remaining.

12. The part finally was double-bagged in clean polypropylene heat-sealed packaging.

In the foregoing process, the composition of the pickling bath in step 1 may be varied, to correspondingly achieve a desired recycle lifetime of the parts.

### EXAMPLE 2

In this example, a GV-2 bellows was cleaned and passivated by the process set out below.

Cleaning and Passivation Process

1. The O-ring groove on the bowl of the GV-2 bellows was polished with 600 mesh alumina paste to remove adhered O-ring debris.

2. The outside of the bowl and outside edge of the opposing flange were polished with 600 mesh alumina paste to remove brown organic deposits.

3. Excess polishing paste was wiped off with a polyester clean room wipe.

4. The bellows was pickled in an aqueous solution containing 1.1 wt. % HF and 9.5 wt. % HNO₃, at 53° C. for 10 minutes.

5. The bellows next was rinsed in a first DI water rinse bath for 10 minutes. The outside surface of the bowl was wiped with a polyester clean room wipe.

6. The bellows was passivated in an aqueous solution containing 34.0 wt. % HNO₃, at 53° C. for 30 minutes.

7. The passivated bellows was soaked in the first DI water rinse bath for 10 minutes, irrigating the weld joints and screw holes with deionized water.

8. The bellows next was soaked in a second deionized water rinse bath for 30 minutes.

9. The bellows next was soaked in a third water rinse bath for 30 minutes.

10. The weld joints and screw holes of the bellows were irrigated with IPA.

11. The bellows was oven dried at 110° C. for 60 minutes.

12. The bellows was cooled to room temperature.

13. The bellows was CO₂ snow blasted in a Class 100 clean room environment.

14. The cleaned and passivated bellows was double-bagged in polyethylene.

In the foregoing procedure, the bellows were pumped at 5 minute intervals in each bath to force liquid in and out of the bellows leaves.

### EXAMPLE 3

In this example, the processes of Examples 1 and 2 were applied to cleaning of parts of a Hitachi M308 metal etcher tool operating in a semiconductor manufacturing facility, and results of the cleaning and passivation procedures of the invention were compared to the results obtained in the manufacturing facility using a conventional abrasive cleaning process. In the manufacturing facility, the metal etcher tool performed a total of six metal etch operations (MT1, MT2, MT3, MT4, MT5 and MT6) on each wafer. MT1, MT3 and MT5 were monitored in this study, to generate data representative of all six etch steps.

In the comparison tests, blocked etch events, small particle densities, surface particle densities and defect densities were monitored in the three etch steps MT1, MT3 and MT5. The data for these monitored parameters are set out in Table 1 below, for the process of the invention (application of the Example 1 process to the non-bellows components of the metal etcher tool, and application of the Example 2 process to the bellows components of the tool), and the abrasive cleaning process that had previously been conducted in the manufacturing facility.

TABLE 1

| | | | Change in Monitor |
|---|---|---|---|
| | | | Parameter for |
| | | | Cleaning/Passivation |
| | | Cleaning/Passivation | Process of Examples |
| | Abrasive Cleaning | Process of Examples | 1 and 2, Relative to |
| | Process | 1 and 2 | Abrasive Cleaning |
| Monitor | Mean ± 3σ | Mean ± 3σ | Process |
| MT1 Blocked Etch | 3.87 ± 4.65 | 1.50 ± 2.68 | 61% Decrease |
| MT1 Small | 0.890 ± 1.29 | 0.500 ± 0.786 | 44% Decrease |
| Particles | | | |
| MT1 Surface | 4.24 ± 5.68 | 1.89 ± 1.64 | 55% Decrease |
| Particles | | | |
| MT1 Defect | 0.124 ± 0.167 | 0.092 ± 0.076 | 26% Decrease |
| Density | | | |
| MT3 Blocked Etch | 1.94 ± 3.85 | 1.17 ± 1.50 | 40% Decrease |
| MT3 Small | 1.11 ± 3.39 | 0.500 ± 0.857 | 55% Decrease |
| Particles | | | |
| MT3 Surface | 4.11 ± 6.26 | 1.72 ± 2.05 | 58% Decrease |
| Particles | | | |
| MT3 Defect | 0.232 ± 0.665 | 0.165 ± 0.317 | 29% Decrease |
| Density | | | |
| MT5 Blocked Etch | 0.591 ± 0.897 | 0.500 ± 0.650 | 15% Decrease |
| MT5 Small | 3.52 ± 5.35 | 1.14 ± 1.51 | 68% Decrease |
| Particles | | | |
| MT5 Surface | 3.32 ± 4.23 | 2.64 ± 2.41 | 21% Decrease |
| Particles | | | |
| MT5 Defect | 0.250 ± 1.09 | 0.090 ± 0.079 | 64% Decrease |
| Density | | | |

In the comparative testing, the abrasive cleaning process was found not to effectively remove contamination from the surfaces of bellows diaphragms on some parts. The process of the present invention, by contrast, was found to effectively remove such contamination, as well as all contaminants and particles, including corrosion deposits, from every surface of the parts, and to reestablish the chromium oxide passivation coating on the steel.

The cleaning/passivation process of the present invention provided a substantial (approximately 50%) reduction in blocked etch events, small particle densities, and surface particles in all metal etch levels processed in the tool, thereby providing a major positive impact on die yield from the manufacturing system. In addition, the cleaning/passivation process of the invention provided a cost reduction of the kit, of about 21%.

In the use of the Hitachi M308 metal etcher tool with the abrasive cleaning process, the average number of wafers that were run between successive programmed maintenance cycles was 2200. Kits cleaned and passivated by the process of the invention were then installed in 8 tools. Six of the tools ran more than 2500 wafers before the next maintenance cycle was required. The other two tools ran between 2200 and 2500 wafers. It therefore was demonstrated that the cleaning/passivation process of the invention achieved a substantial improvement in on-stream run operation before maintenance is required. This improvement in turn provides a major positive impact on process economics of the semiconductor manufacturing facility.

### EXAMPLE 4

Two GV-2 bellows from a semiconductor manufacturing facility were inspected and two primary forms of corrosion were observed. Pit corrosion was observed around the entire outside circumference of the bowl, as evidenced by a reddish tint on the surface of the bowl. The pit corroded area was located between the O-ring flange of the bowl and the transition flange connecting the bowl to the bellows. The second form of corrosion, surface corrosion with no pitting, covered only a small area on the inside of the bowl, under the rim of the O-ring flange. The O-ring flange and the transition flange on the bellows were connected by a single band of metal, and all corrosion sites were located on either the inside or the outside of this metal band. This suggests that a galvanic mechanism may be responsible for the observed corrosion.

It is well established that stainless steel derives its resistance to chemical attack and corrosion from a chromium oxide layer that forms on the surface of the metal. The data presented in Table 2 represents cleaning results (atomic concentration of various elements) obtained on 304 stainless steel coupons cut from a bead blasted spring holder (BBSH) previously used in a Hitachi M308 tool operated in a semiconductor fab.

TABLE 2
X-ray Photoelectron Surface Analysis of 304 Stainless Steel Coupons

| | Atomic Concentration in Percent | | | | | | | | | | | |
|---|---|---|---|---|---|---|---|---|---|---|---|---|
| | C | N | O | F | Al | Si | Cl | Cr | Fe | Ni | Mo | Ti |
| Bulk 304 | — | — | — | — | — | 0.4 | — | 18 | 73 | 8.4 | 0.2 | — |
| Stainless | | | | | | | | | | | | |
| Steel | | | | | | | | | | | | |
| Alumina | 21 | 0.8 | 51 | 0.9 | 11 | 1.5 | 0.5 | 3.0 | 8.0 | 0.4 | — | 0.2 |
| Bead | | | | | | | | | | | | |
| Blasted | | | | | | | | | | | | |
| Pickled | 17 | 2.3 | 50 | 0.9 | — | 1.1 | — | 16 | 9.4 | 3.0 | — | — |
| and | | | | | | | | | | | | |
| Passivated | | | | | | | | | | | | |

The first row in Table 2 (“Bulk 304 Stainless Steel”) shows the bulk concentrations of the primary components in the steel. This material appears to be of foreign origin and contains a small amount of molybdenum, but not enough to perform as a 316 grade alloy. The primary component of the steel is iron. This element is easily oxidized, forming a non-passivating friable surface film that grows continuously without stopping. Formation and mass wasting of the red iron oxide was the source of the corrosion observed on the GV-2 bellows.

When properly treated, the surface concentration of the chromium in stainless steels can be selectively enhanced, forming an oxide film that grows to a limiting thickness and then stops. Chromium and its oxides are much more stable and resistant to chemical attack than iron, forming a barrier layer that protects the steel from corrosion.

The second row of Table 2 (“Alumina Bead Blasted”) shows the surface composition of a coupon cleaned by alumina bead blasting. This surface was heavily oxidized but exhibited a Cr/Fe ratio (0.375) very similar to the ratio present in the bulk steel (0.247). The chromium passivation layer has reformed to only a small extent after bead blasting. Because of its high iron content, this surface was susceptible to corrosion, especially in the presence of chlorine, which promoted rapid oxidation of iron.

The last row in Table 2 (“Pickled and Passivated”) shows a BBSH coupon cleaned and passivated with the process of the present invention. The surface on this coupon was oxidized to roughly the same extent as the bead blasted surface, however, the chromium content was dramatically higher and the measured Cr/Fe ratio was 1.702, indicating that a thick chromium oxide layer was formed on the surface of the steel. Due to this chromate layer, the HF/HNO₃ treated stainless steel surface was much more resistant to chemical corrosion than the bead blasted surface.

### EXAMPLE 5

A Vector 5001 abatement system with a Type 14 entry head (commercially available from ATMI, Inc., San Jose, Calif.) was operated for abatement of silane contaminated semiconductor waste streams.

This entry head contained a 316 stainless steel porous metal ring through which nitrogen gas was passed into a water scrub chamber. The size of the pores in this metal ring were nominally 2 microns. During normal operation of this abatement tool, the porous metal ring was exposed to significant amounts of solid precipitates that eventually clogged the pores in the ring, reducing the flow of nitrogen into the abatement system. A cleaning procedure according to the present invention was employed to remove the solid precipitates from the pores in the ring and to restore the gas flow rate through the entry head to normal values, and to remove the solid buildup of precipitate material from the wetted surfaces and critical orifices of the entry head.

The entry head included a porous metal ring surrounding a short central tube in the middle of a flange. Nitrogen gas was fed into the porous metal ring through a plenum located on top of the flange. The solid deposits found on the interior surfaces of the part after extended abatement system operation were typical of deposits generally found in such systems after substantial on-stream operation—the deposits can range up to approximately 10 mm thickness and typically have either a white, light green, or rust colored appearance.

The following cleaning process was carried out for parts constructed entirely of 300 series stainless steels.

Cleaning Process

1. Remove the flexible gas line manifold from the entry head assembly at the Swagelok® compression fittings. Wipe the manifold clean with DI water. Save for reassembly.

2. Remove the tube weldment at the threaded pipe joint on top of the entry head and group this part with the entry head for acid cleaning.

3. CO₂ ice blast the tube weldment and entry head to remove as much of the heavy buildup of solid precipitate on the exposed surfaces of the parts as possible.

4. If not already present, laser scribe a unique serial number on the top plate of the entry head plenum. Record this serial number in the entry head cleaning log each time an entry head is processed through the cleaning procedure noting any rework procedures required.

5. Connect the liquid diaphragm pump to the nitrogen port of the entry head plenum using a ¼″ tube to ¼″ NPT PVDF plastic fitting.

6. Note: In steps 7 through 12 below, the bath solution must be pumped into the plenum of the entry head and out through the porous metal ring at a constant flow rate of 600 milliliters/minute over the entire treatment period specified. Insert the tube weldment and entry head into each bath so that air bubbles trapped in the internal cavities of the parts are allowed to escape. Drain the pump line, plenum, and internal cavities of the parts before transferring them between baths to minimize solution carryover.

7. Pickle the entry head and tube weldment in a 1.1 wt. % HF, 9.5 wt. % HNO₃ aqueous solution at 53° C. for exactly 10 minutes.

8. Soak each part in the first DI water rinse bath for 10 minutes to remove the acid residues.

9. Passivate the entry head and tube weldment in a 34.0 wt. % HNO₃ aqueous solution at 53° C. for 30 minutes.

10. Again, rinse each part in the first DI water rinse bath for 10 minutes to remove the acid residues.

11. Sonicate the entry head and tube weldment in the second DI water rinse bath for 30 minutes. Alternate ultrasonic frequencies continuously between 40, 72 and 104 kHz in 10 second bursts throughout this treatment period.

12. Soak each part in the third DI water rinse bath for 30 minutes.

13. Disconnect the pump from the entry head and remove the PVDF fitting.

14. Oven dry the entry head and tube weldment at 110° C. for 60 minutes.

15. Cool the entry head and tube weldment to room temperature.

16. Inspect both parts for surface defects noting any remaining contamination and any deterioration of the O-ring sealing surface. Verify that the six gas ports and the center bore of the tube weldment are open and clear. Submit parts for rework if any deviations from specifications are noted. P 17. Assemble the tube weldment into the threaded pipe joint on top of the entry head and tighten to the stated torque specification. Connect the flexible gas line manifold to the entry head ports.

18. Final assembly inspection (to be performed by someone other than the part assembler): Verify that the tube weldment is installed correctly. Verify that the flexible gas line manifold connections match the diagram provided.

19. Heat seal the entry head assembly in a polypropylene bag. Label with the serial number on the outside of the bag.

On the entry head after disassembly but before cleaning, the central tube and internal surfaces of the flange were heavily encrusted with precipitate residue. After CO₂ ice blasting, the heavy buildup of friable contamination on the parts was removed, thereby minimizing the mass of contaminant material introduced into the acid baths. Only a thin layer of contamination and corrosion products remained on the surface of the part after this cleaning step.

After acid cleaning, wetted surfaces of the entry head had a whitish appearance, which however was not due to contamination remaining on the surface of the steel, but rather resulted from surface roughness attributable to corrosion of the steel by the chemicals that were present in the abatement system, which caused Lambernian backscatter of light from the surface of the metal resulting in the observed milky white appearance.

Results of X-ray Photoelectron Spectroscopy (XPS) analysis are presented in Table 3 for the light green crystalline material that was removed from the inside tube of the entry head. This green material was composed primarily of metal fluorides (52 at. %), generic hydrocarbons (22 at. %), and inorganic oxide salts (23 at. %). The metal fluorides most likely arose from corrosion of the stainless steel surfaces in the abatement system. The presence of metallic particles in the contaminant residue suggests that significant abrasion may have occurred somewhere within the abatement system or at a location upstream from the abatement system.

TABLE 3
XPS Analysis of Light Green Crystalline Contamination

| | Binding | Composition | |
|---|---|---|---|
| Transition | Energy (eV) | Atomic % | Peak Assignment |
| C(1s) | 284.7 | 19.7 | Aliphatic Hydrocarbon |
| | 287.0 | 2.6 | C—O Hydrocarbon |
| | 289.2 | 1.5 | CO₃⁻² |
| N(1s) | 406.8 | 2.8 | NO₃⁻¹ |
| O(1s) | — | 14.7 | Broad Complex Peak |
| | | | Structure Not |
| | | | Analyzed |
| F(1s) | — | 39.0 | Broad Complex Peak |
| | | | Structure Not |
| | | | Analyzed |
| Si(2p) | 107.6 | 3.2 | Charged SiO₂ Particles |
| S(2p) | 166.6 | 0.2 | SO₃⁻² or SO₄⁻² |
| | 172.8 | 0.5 | Sulfur Oxyfluoride ?? |
| Cr(2p_{3/2}) | 582.2 | 0.6 | CrF₃.xH₂O |
| | 584.2 | 0.9 | CrF₆⁻³ |
| Ni(2p_{3/2}) | 857.6 | 5.9 | NiF₂.4H₂O |
| | 860.8 | 5.7 | NiF₆⁻² |
| Mo(3d_{5/2}) | 228.0 | 2.9 | Mo Metal |

Surface compositions measured by XPS on coupons from the wetted surface of the 304 stainless steel entry head flange are presented in Table 4 below.

TABLE 4
XPS Analysis Results on the 304 Stainless Steel Flange

| | Surface Concentration in Atomic Percent | | | | | | | | |
|---|---|---|---|---|---|---|---|---|---|
| | C | N | O | F | Si | Ca | Cr | Fe | Ni |
| White Residue on | 5.5 | — | 51 | 7.7 | 18 | 0.5 | 3.7 | 13 | 0.6 |
| Surface after CO₂ Ice | | | | | | | | | |
| Blasting (Xe Ion | | | | | | | | | |
| Sputtered) | | | | | | | | | |
| Final Surface | 12 | 0.5 | 54 | 0.7 | 0.4 | — | 19 | 10 | 3.4 |
| Composition After | | | | | | | | | |
| Acid Cleaning | | | | | | | | | |

The first row of data in this table (“White Residue on Surface after CO₂ Ice Blasting (Xe Ion Sputtered)”) shows the bulk composition of the white residue remaining on the surface of the entry head flange after the CO₂ ice blasting step. This surface was sputtered with Xe ions prior to XPS analysis to remove the organic residue and metal oxide layer left on the material by the CO₂ ice blasting process. The white residue was primarily SiO₂ (binding energy=102.9 eV) with small amounts of Fe₂O₃, Cr₂O₃, NiO, and various hydrocarbons present. The existence of this silica at the contaminant/metal interface was the primary reason HF was required in the pickling solution to remove the contamination from this part.

The second row of data in Table 4 (“Final Surface Composition After Acid Cleaning”) shows the final surface composition of the flange after acid cleaning. The acid cleaning process completely removed the SiO₂ from the surface of the steel. The residual Si observed in the XPS spectra was intermetallic silicon (binding energy=99.5 eV), which was a minor bulk component of the steel. The pickling bath left a trace amount of fluorine on the surface of the metal (in this case about 6% of a monolayer), which was not soluble in the passivation solution. The purpose of the passivation step was to enhance the chromium oxide content on the metal surface by selectively leaching away the iron. This chemical process maximized the thickness of the chromium oxide fihn on the surface of the metal, thereby ensuring optimum corrosion protection for the steel. The carbon and nitrogen residues remaining on the surface of the steel after acid cleaning were unavoidable contamination adsorbed from the ambient air.

The 304 and 316 grades of stainless steel were not attacked by nitric acid at aqueous concentrations less than 70 wt. %. However, when nitric and hydrofluoric acids are mixed together, as in the pickling solution used to remove silica contamination from the entry head in this experiment, slow erosion of the steel substrate will occur.

By monitoring the thickness of the surface layers removed from 304 stainless steel as a function of time, measured by the dissolution of Fe, Cr, and Ni into the pickling solution by ICP-MS, the etch rate of the 304 stainless steel in 1.1 wt. % HF, 9.5 wt. % HNO₃ at 53° C. was determined to be 0.054 μm/min. The corresponding etch rate for 316 stainless steel is expected to be approximately ⅓ the rate observed for 304 stainless steel. Note that in the cleaning process described above, the exposure time of the entry head in the pickling solution for one complete cleaning cycle was 10 minutes. At that rate, it is possible to perform at least 23 cleaning cycles before 0.001 inches (25 μm) of substrate material is removed from any critical dimension of the part.

The primary objective of the cleaning procedure for the Type 14 entry head is to remove solid precipitates from the internal pores in the porous metal ring and to restore the gas flow rate through the ring to normal values. To demonstrate that this objective has been adequately met, pressure drop tests were performed as a function of nitrogen gas flow rate, on five new entry heads and two acid cleaned heads.

The test apparatus for this determination consisted of a flow restricting orifice with pressure transducers located on either side. Pressure transducer P1 was disposed upstream of a 0.052 inch brass orifice, and 108 inches downstream from the N₂ supply in the flow line. Pressure transducer P2 was disposed in the flow line 1 inch downstream of the brass orifice, and upstream 8 inches from the entry head. The difference in the pressure sensed by the two transducers P1 and P2 provided a direct measurement of the pressure drop across the orifice. The entry head was connected to the nitrogen flow line downstream from the orifice. As long as the flow resistance introduced by the porous ring in the entry head was much less than the flow resistance characteristic of the orifice, the pressure drop across the orifice was a monotonic function of the orifice diameter and the flow rate through the orifice. However, if the flow resistance of the porous ring increased to roughly 0.1 times the flow resistance of the orifice, the pressures at P1 and P2 in the nitrogen line for a given flow rate increased and the pressure drop across the orifice decreased. To pass this pressure drop test, an entry head must exhibit no significant effect on the pressure drop across the orifice, which means that the internal flow resistance of the porous ring in the entry head must be much less than the flow resistance of the orifice.

Pressure drop tests were performed on the five new entry heads and two heads that were reconditioned by the acid cleaning process described above in this Example. The pressure drop functions measured for the two acid cleaned entry heads fell well within the range of values measured for the new heads. Within statistical measurement error for this performance parameter, the new and acid cleaned entry heads were indistinguishable.

### EXAMPLE 6

In this Example, an acid cleaning process was demonstrated for the Hitachi M308 ash reflector.

The cleaning process is set out below.

Cleaning Process

1. Pickle the ash reflector in a 1.1 wt. % HF, 9.5 wt. % HNO₃ solution at 53° C. for exactly 2 minutes.

2. Rinse the pickled part in a first DI water rinse bath for 10 minutes to remove acid residues. During this rinse step, wipe the pickling smut off all exposed surfaces of the part with a clean polyester wipe.

3. Soak the ash reflector in a 34.0 wt. % HNO₃ aqueous solution at 53° C. for 2 minutes.

4. Again, rinse the part in the first DI water rinse bath for 10 minutes to remove the acid residues.

5. Soak the part in a second DI water rinse bath for 30 minutes.

6. Soak the part in a third DI water rinse bath for 30 minutes.

7. Dry the part by spray rinsing with absolute reagent grade isopropyl alcohol. Allow the alcohol to air evaporate from the surface of the part after this rinse step.

8. All process steps from this point forward must be performed in a Class 100 clean room environment.

9. Thoroughly CO₂ snow blast the ash reflector on all surfaces.

10. Inspect surfaces of the part for residual contamination and for stress corrosion cracking of the aluminum metal.

11. Double bag the ash reflector in a clean room grade polypropylene bags.

Scanning electron microscopy (SEM) top-down images were made of the rainbow-colored contaminant film on the ash reflector as received, and showed a nodular growth pattern with many thinly adhered flake and particle structures. Results of X-ray photoelectron spectroscopy (XPS) analysis of the contaminant film are presented in the second and third columns of Table 5 below. The contaminant film was composed primarily of aluminum oxide with some carbide, oxynitride, and fluoride present. Sulfur was present in the film as both a sulfate and an oxyfluoride species. The aluminum oxide film was very rich in oxygen, indicating that a high density of defect sites existed in the crystalline lattice of this material. Seventy seven percent of the carbon observed in the as-received surface spectra was removed by ion sputtering to a depth of 500 Å. This indicated that the hydrocarbons and fluorocarbons observed in the XPS spectra were primarily on the surface of the aluminum oxide film.

SEM micrographs of the surface of the ash reflector taken after etching in the pickling bath for 60 seconds, showing that part of the contaminant film had been removed from the surface and revealing the presence of large numbers of alumina bead blast particles embedded in the underlying metal. The alumina particles were deposited in the soft aluminum metal during previous bead blast cleaning of this part. The bead blast particles were evident in the micrographs because they etched much more slowly due to their defect-free α-Al₂O₃ crystal structure than the contaminant film or the metal substrate. In many areas, the embedded particles were so numerous that they formed a close packed solid mat extending over a significant fraction of the surface. The sizes of these particles ranged from 12 μm to roughly 0.2 μm.

TABLE 5
XPS Analysis of the Ash Reflector Surface Before and
After Acid Cleaning

| | As-Received | | Acid Cleaned | | |
|---|---|---|---|---|---|
| | | Atomic | | Atomic | |
| | BE(eV) | % | BE(eV) | % | Peak Assignment |
| C(1s) | 283.0 | 5.62 | — | — | Aluminum Carbide |
| | 285.0 | 24.5 | 285.0 | 17.0 | Aliphatic Hydrocarbon |
| | 287.0 | 4.04 | — | — | Ester C—O Linkage |
| | 289.2 | 2.07 | 288.9 | 1.71 | Ester C═O Linkage / |
| | | | | | Carboxylic Acid |
| Al(2p) | — | — | 72.2 | 5.86 | Aluminum Metal |
| | 74.5 | 13.0 | 74.4 | 19.4 | Aluminum Oxide |
| N(1s) | 398.4 | 0.59 | — | — | Aluminum Oxynitride |
| | 400.3 | 0.58 | 399.4 | 0.22 | Organic Nitrogen |
| | — | — | 401.6 | 0.12 | Organic Ammonium Ion |
| O(1s) | 531.6 | 30.9 | 531.7 | 20.6 | Aluminum Oxide |
| | 533.9 | 13.1 | 534.3 | 5.06 | Water |
| F(1s) | 685.6 | 1.17 | 685.8 | 0.66 | Aluminum Fluoride |
| | 686.9 | 1.04 | 687.1 | 1.04 | Fluorocarbon |
| | 689.3 | 0.35 | — | — | Perfluorocarbon |
| Si(2p) | 101.1 | 0.98 | 101.7 | 2.66 | Silicon Carbide / Silicon |
| | | | | | Suboxide |
| S(2P) | 169.4 | 1.45 | — | — | Sulfate |
| | 170.9 | 0.65 | — | — | Sulfur Oxyfluoride |

Electron micrographs of the ash reflector surface, after completion of the acid cleaning procedure described earlier in this Example, revealed a metal surface topography characterized by a high density of impact craters peppered with shallow pits from the chemical etch. Adhesion of the contaminant film on this surface was anticipated to be very good due to the abundance of surface structures suitable for mechanical interlocking. After 120 seconds in the pickling bath, all of the small bead blast media particles and almost all of the large particles were removed from the surface of the aluminum. Release of the larger particles from the surface of the metal required more etch time than extraction of the smaller particles because more of the surrounding metal must be removed to release the particles from their impact craters. Increasing the pickling time from 120 to 180 seconds is sufficient for completely removing the large particles from the surface of the metal. However, if the pickling time is left at 120 seconds, these particles will also be extracted during the second cleaning cycle on the part.

After etching the ash reflector in the pickling bath to remove the contaminant film and the embedded bead blast media, a 120 second rinse in 34 wt. % nitric acid was required to remove transition metal residues from the surface of the aluminum. This nitric acid solution did not significantly etch the surface of the aluminum. Instead a thin passivation oxide film was formed. The final composition of the ash reflector after completion of all the clean steps is shown in the fourth and fifth columns of Table 5. The surface composition was dominated by aluminum oxide. In this case, the oxide film was so thin (approximately 100 Å) that the underlying metal was easily observed in the XPS spectra of this surface. No carbides, nitrides or sulfur compounds remained on the surface of the metal. A very small residue of aluminum fluoride was detected on the surface, which was likely formed during etching in the pickling bath. The carbon residues that were observed remaining on the surface were all adventitious hydrocarbons. The adsorption of these hydrocarbons from the ambient atmosphere was unavoidable during normal handling of the parts in air. A small amount of silicon oxide was also detected on the surface of the aluminum after cleaning, as a minor contaminant deriving from the aluminum substrate.

The foregoing shows the application of a process of the invention to an aluminum substrate.

### EXAMPLE 7

A stainless steel wet cleaning line set up for temporary servicing of GV-2 bellows from a semiconductor manufacturing facility was shut down due to pitting incidents observed on the lower flange of three bellows. In each case, the pitting was severe enough to render the O-ring sealing surface on the flange unusable. The pits in the surface of the metal were on the order of 100 μm deep. Each GV-2 bellows was composed of 5 separate pieces of metal welded together. In each pitting incident, only the surfaces of the lower flange showed any visible signs of corrosion. No other surfaces on these parts were affected in any way.

The cleaning process of the invention was applied to a first batch of three GV-2 bellows received for production cleaning from the semiconductor manufacturing facility. These three bellows were processed without incident. A second batch of 17 GV-2 bellows was received for cleaning. A first bellows cleaned from this batch pitted after approximately 7.5 minutes exposure in the pickling bath. The normal exposure time for the GV-2 bellows in this bath was 10 minutes. Gas evolution was observed from the surface of the metal during the corrosion reaction indicating that the pitting was caused by a galvanic reaction between electrochemically different metallic phases in the part. This pitting incident occurred in the same pickling solution used successfully to process the three GV-2 bellows from the first batch of parts. A sample of the pickling bath was taken for analysis immediately after this pitting incident. The results of this analysis showed that the solution was of the correct chemical composition and contained no unexpected or excessive impurities.

During the initial phase of the investigation into this incident, the technician operating the cleaning line noted that a physical difference could be observed in surface appearance between the bellows flanges damaged in the pickling solution and those flanges that passed through the solution unharmed. The remaining 16 bellows were inspected and two bellows were found having the same visual appearance as the bellows damaged in the pickling solution.

One bellows having the “normal” (non-pitting) visual appearance was then treated in a freshly prepared pickling solution for 10 minutes. The bellows passed through the solution unharmed and was processed through the remaining cleaning steps without incident. This bellows was returned to the fab labeled as an “Acid Cleaned Part”.

Pickling was then attempted on a second bellows exhibiting the “abnormal visual appearance.” As expected, this bellows evolved gas bubbles from the surface of the part and pitted after 6 minutes in the pickling bath.

Processing then was continued on a third bellows from the “normal” group. After introduction of this part into the pickling bath for a few minutes, a slow evolution of gas from the lower bellows flange was observed. Unfortunately, by the time this bellows was removed from the pickling bath, significant pitting of the polished O-ring sealing surface on the lower flange had already occurred. This result indicated an inability to reliably predict which bellows would pit in the pickling solution on the basis of its visual appearance.

In order to determine if the pitting problem was caused by a progressive chemical degradation of the pickling solution resulting from the successive processing of GV-2 bellows in the bath, an axial coupon, from an original D-test part used to develop the cleaning process for the GV-2 bellows, was treated in the pickling bath. This axial coupon included the original surface contamination present on the part and all 5 metal components connected together by the original welds. After 10 minutes exposure to the pickling solution, all the contamination present on this coupon was completely removed. However, no degradation of any of the metal surfaces on the coupon was observed as a result of the acid treatment. The same result was obtained after treating this coupon for an additional 20 minutes in the pickling bath. This experiment demonstrated that the pitting problem was due to an abnormal physical property of some of the GV-2 bellows received from the fab, and was not due to an uncontrolled parameter in the cleaning process or degradation of the chemicals in the pickling bath.

During corrosion of the GV-2 lower flanges in the pickling bath, a fine insoluble powder was released from the surface of the flange into the solution. This observation indicated that the metal was being attacked by an intergranular corrosion mechanism, which is well known for 300 series stainless steels. Surface cross sections taken from an acid-resistant and acid-sensitive bellows flange treated in the pickling bath for 10 minutes were compared. Optical micrographic study of the acid-resistant metal revealed no significant surface pitting, but grain boundaries could not be readily observed in the bulk volume of this metal. Optical micrographic study of the cross-section of the acid-sensitive metal exhibited very obvious grain boundaries and revealed that the pickling acid had etched away the intergranular material at the surface of the metal. Continuous progression of this etch mechanism had resulted in the release of the insoluble grains into the acid solution as was observed.

Metallographic cross-sections of the acid-resistant and acid-sensitive GV-2 lower flanges treated to reveal the fundamental microstructure of the metal revealed that the acid-resistant flange possessed the normal microstructure typical of AISI 300 series stainless steels, with grains exhibiting linear boundary segments with no obvious precipitates between the grains. The acid-sensitive flange, however, evidenced the microstructure typically produced when an austenitic stainless steel with significant carbon content has been improperly heat-treated. Compared to the acid-resistant metal, the grains in the acid-sensitive metal were smaller and irregular in shape, with heavy dark-colored precipitates present in the spaces between the grains and at other crystal defect sites in the metal. The dark-colored precipitates were chromium carbides (primarily Cr₂₃C₆) formed by the reaction of carbon with chromium as the metal was cooled slowly in the temperature range between 815° C. and 425° C. during heat treatment. This chromium carbide precipitation reaction depleted the chromium at the edges of the metal grains, leaving these areas susceptible to preferential corrosion by the pickling solution. In AISI 300 series stainless steel which has been correctly heat-treated, the fully-annealed metal is quenched rapidly through the 815° C. to 425° C. temperature range, to prevent chromium carbides from forming.

The foregoing showed that the cause of the pitting problem on the GV-2 bellows from the fab was improper heat treatment of the stainless steel in the lower flanges on these parts, leaving the parts sensitive to chemical attack and corrosion by the pickling solution.

The normal corrective action for chemical sensitization in austenitic stainless steels is to modify the metallurgy of the steel. The addition of chromium to steel at concentrations higher than 10% produces a metal with significant resistance to chemical attack and corrosion. However, if chromium carbides are allowed to precipitate in the grain boundaries of the metal during heat treatment, the steel will not exhibit the corrosion resistance characteristic of the stainless steel grades. Two metallurgical solutions to this problem are possible: (1) verification upon receipt of parts from the manufacturer that the steel has been correctly heat treated; and (2) using only L grade stainless steels, which contain carbon concentrations that are too low for the precipitation of chromium carbides to occur.

Once identified, these sensitized parts can be handled in a suitable manner, e.g., by replacement of the sensitized metal component on the bellows with a new component manufactured from AISI 316L stainless steel, or alternatively by replacement of the entire bellows assembly with a new bellows manufactured entirely from AISI 316L stainless steel.

As a still further alternative, the sensitized GV-2 bellows assembly could be cleaned by using a conventional mechanical bead blast process, while corrosion-resistant GV-2 bellows assemblies constructed of appropriately produced stainless steel materials would be cleaned using the less expensive and more efficient acid pickling process of the present invention. It therefore is apparent that stainless steel parts constructed of AISI 316L stainless steel simplify cleaning and extend the reusable lifetime of these parts.

### EXAMPLE 8

The wet cleaning process of the present invention in application to semiconductor processing tool parts was demonstrated to effectively remove contamination deposits from the surfaces of parts such as bead blasted spring holder (BBSH) and bellows parts, including contamination deposits that were not removed by previously employed cleaning processes.

Table 6 below shows the average arithmetic surface roughness (Rα) and standard deviation (σ) measured after pickling at three different sites on parts from stainless steel kits of semiconductor processing tool components. All the parts listed in this table were exposed to the pickling bath for exactly the same amount of time, 60 minutes±30 seconds.

Note that the range of ±2σ around Rα covers 95.5% of the population of a standard Gaussian distribution. The order in which theses parts were processed through the pickling bath is indicated in the first column in the table. Note that the standard deviations for the roughness values measured on these parts were tightly grouped in the range of 4.8 to 5-3 μinch, indicating that the uniformity of the surface finish was roughly equivalent on all the parts.

TABLE 6
Results of BBSH Surface Roughness Measurements

| Process | Part | Visual | Average | | ±2σ |
|---|---|---|---|---|---|
| Order | Identification | Appearance | Rα (μinch) | σ (μinch) | Limits (μinch) |
| 1 | F11-31 | Patterned | 141.8 | 4.8 | 128.4 |
| 2 | F11-32 | Uniform | 139.3 | 5.2 | 128.9-149.7 |
| 3 | F11-29 | Uniform | 138.9 | 5.0 | 128.9-148.9 |
| 4 | F11-30 | Patterned | 154.2 | 4.8 | 144.6-163.8 |
| 5 | BBSH | Uniform | 118.7 | 5.3 | 108.1-129.3 |
| | Coupon | | | | |

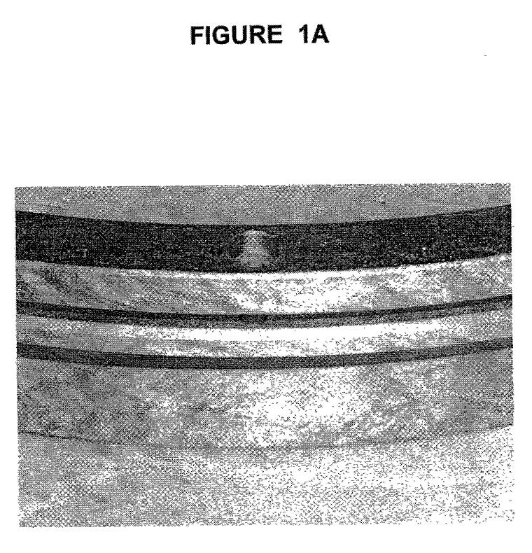

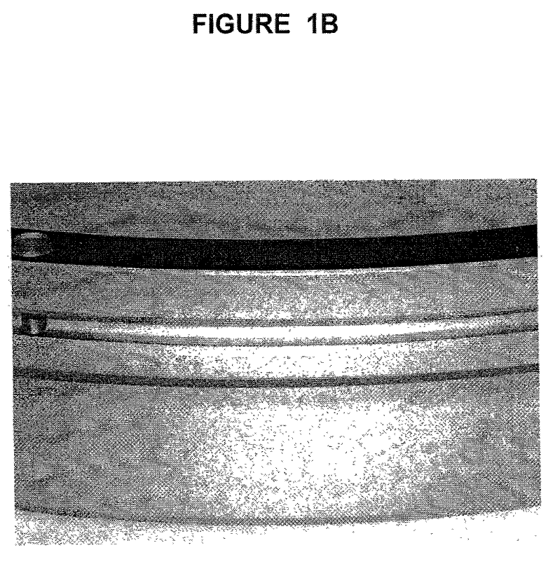

However, based on the 2σ limits indicated in the table, the absolute roughness values showed three statistically different etch results. The first three BBSH parts processed through the pickling bath show Rα values grouped into a narrow range of 139 to 142 μinch Rα. Interestingly, the visual appearance of first part pickled in the bath was very different from the appearance of the other two. FIG. 1A shows the “patterned” surface finish obtained on Part F11-31. This finish was obtained on both the inside and outside surfaces of the BBSH. Part F11-31 was etched to a sufficient extent to reveal the grain structure of the metal. The patterned appearance of the surface finish on this part was due to spatial variations in the grain structure as a function of position in the part.

Part F11-32 is shown in FIG. 1B and has essentially the same Rα value as F11-31 but exhibited a much more uniform surface finish. This result was a potential indication that the metal in part F11-32 had a much more uniform grain structure than F11-31. However, it is also possible that the metallic grain structure in the two parts was identical but F11-31 had not yet been etched to a sufficient extent to bring out the patterned finish.

Pickling F11-29 produced a surface finish very similar to F11-32, while the surface finish obtained on F11-30 was similar to that on P11-31. The fact that the first and fourth parts processed in the bath exhibited the same patterned surface finish suggested that the observed differences in surface finish were not the result of a change in the chemical activity of the pickling bath, but were instead due to fundamental differences in the chemical etch properties of the metal in the parts. Part F11-30 exhibited a surface roughness roughly 10% larger than the average roughness measured on the other three parts, suggesting that this part may have been more extensively etched in the pickling bath than the other parts. However, it is also possible that the average size of the metallic grains in this part was much larger than that of the grains present in the other parts.

Before becoming aware of an error in the composition of the pickling bath, a coupon was etched from the original BBSH part used in process development to determine whether the 80 to 90 μinch Rα surface roughness originally produced on this part could be duplicated. Results are shown in the fifth row of Table 6. After treatment in the pickling bath, the original BBSH coupon exhibited the same visually uniform surface finish obtained in initial processing studies. However, the measured Rα, value was 118.7 μinch, about 40% larger than the surface roughness originally detemined. This value was much lower than the surface roughness values obtained on any of the four BBSH qualification parts. An increase in acid concentration in the pickling bath therefore resulted in an increase in the surface roughness of the BBSH. This result was interesting since doubling the exposure time of the BBSH in the pickling bath at the original acid concentration produced no significant change in surface roughness. Nevertheless, it was clear from the foregoing results that differences in etch properties of the metals in the different BBSH parts produced significant differences in the surface roughness obtained during pickling of these parts.

Optimal surface roughness was determined to reside in a range of 50 to 200 μinch Rα. Roughness values less than 50 μinch and values greater than 200 μinch resulted in premature film delamination and particle spallation from exemplary Si₃N₄ films deposited on collateral surfaces of a physical vapor deposition (PVD) tool. However, within the range of 50 to 200 μinch Rα, particle generation rates in the tool were at the minimum value observed, and surface roughness had no effect on the thickness where breakup of the Si₃N₄ film began to occur.

In these determinations, the substrate material was found to have no substantial effect on the range of surface roughness values exhibiting minimal film breakup. A very smooth surface (<50 μinch Rα) resulted in premature particle generation in the tool. The upper limit in acceptable surface roughness on these parts was not determined in these studies, but an acceptable upper limit is readily determinable within the skill of the art, by comparative empirical tests at varying surface roughness values. In general, pickling bath acid concentrations are preferred that produce roughness values near 90 μinch Rα, to accommodate long-term cleaning of these parts, and to minimize the amount of metal etched from the parts during each cleaning cycle.

In addition, surface roughness may also increase slowly with each successive cleaning cycle. Therefore, starting at a value of 90 μinch, farther away from the upper roughness limit, allows more cleaning cycles to be performed before one must redress the surface finish to a lower roughness value. Consistent with the data presented above, one may expect that roughness values produced by the acid pickling could vary by as much as ±20 μinch about any given target Rα value, as a result of differences in material response to the pickling solution.

Acid pickling during the cleaning process removes metal from the stainless steel parts. The amount of metal removed will be proportional to the exposure time of the part in the pickling bath. Acid removal at the site of embedded media may be accelerated due to damage of the chromium oxide layer caused by embedded media. Pickling times greater than 30 minutes should be considered a one-time treatment necessary to remove debris embedded in the stainless steel surface as a result of previous bead blast and Scotchbrite® treatments. After this debris has been removed, pickling times should be shortened to minimize further metal removal from the parts. Polishing a stainless steel surface with Scotchbrite® cleaning media will also leave debris embedded in the surface of the steel, although to a much smaller extent than with bead blasting.

After the embedded debris has been removed from the surface of the steel, the removal of subsequent process deposits typically requires only about 10 to about 30 minutes exposure to the pickling solution. In order to minimize the removal of metal from the parts and stabilize surface roughness, each part may optionally be marked with a unique identification number so that the surface roughness and number of cleaning cycles performed on each part can be tracked. One such technique for such marking is to inscribe these parts by a laser inscription. After initial removal of embedded debris, the pickling time should be shortened so that the part is exposed to the pickling solution only for the minimum time necessary to remove the process deposits. In addition, the parts should not be exposed to any other cleaning process that will reintroduce embedded foreign deposits into the surface of the part. After the parts have reached their maximum roughness limit, electropolishing may be used to restore the original roughness values on critical surfaces, without reintroducing embedded debris into the surface of the part.

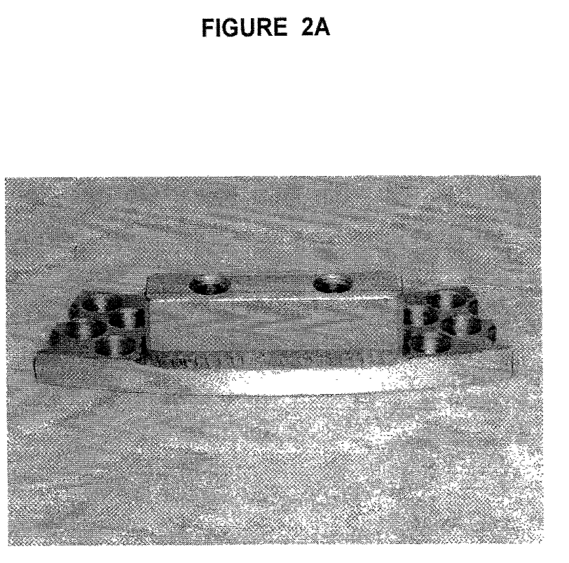

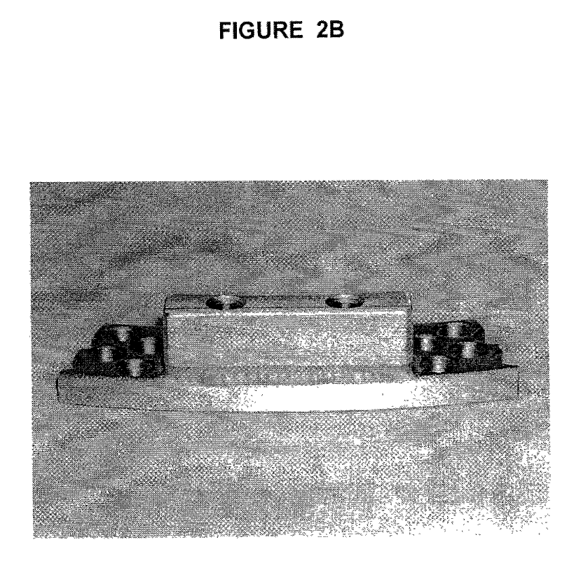

Pickling of qualification parts was observed to visibly increase the surface roughness on all the parts. In addition, several grades and tempers of stainless steel were encountered on the parts, and the various materials responded differently to the pickling solution. The BBSH exhibited the most dramatic change in surface roughness. However, visible changes in roughness were also observed on all the other parts in the stainless steel kit. All the exposed welds on the parts exhibited a thin black surface discoloration after pickling. An example is shown in FIG. 2A for a weld on a ground ring coupon. This discoloration is referred to as a pickling smut in the metal processing literature. Pickling smut is the result of intergranular attack of the metal by the acids in the pickling solution, leaving the grains exposed on the surface of the metal as friable particles. The smut will produce a black mark on a white cloth when the cloth is wiped across an affected surface. The smut could not be completely removed from the surface of the part by deionized (DI) water soaking, polishing with a clean white cloth, or CO₂ ice blasting, but was very effectively removed from the surface of the steel by a final CO₂ snow blasting step (See FIG. 2B). A small amount of surface smut formed on both flanges of the GV1 bellows during pickling. This smut was also completely removed in the CO₂ snow blast step. No smut formation was observed on the leaves of the GV1 bellow or on the butt welds joining the bellows leaves together.

Difficulties were also initially encountered removing the pickling solution and associated smut particles from the crevices and threaded screw holes in a GV1 bellows, clamp ring and the two bellows shields. Initially, Teflon® blocks were used to separate the leaves of the bellows. This approach resulted in differential etch marks on the surface of the bellows flange where the blocks contacted the flange, but did not effectively improve drainage from the weld crevices in the bellows. Leaving the bellows free so that they could be pumped up and down in solution and squeezed out to facilitate effective drainage worked much better. Direct irrigation of the screw holes with DI water also proved effective. A third DI water bath was added after each acid exposure to ensure complete removal of the acid residues. Ultrasonic agitation in one or more of the DI water rinse baths may be employed to further mitigate this problem.

During initial processing of the part containing a bellows, surface stains similar in appearance to water marks were noted on the surface of the bellows flanges after the bellows were oven dried at 110° C. Unlike other surface stains encountered, the stains on bellow flanges could not be removed by wiping with isopropyl alcohol (IPA) or blasting with either CO₂ ice or snow. Reprocessing the bellows by heating them to 110° C. and polishing the affected areas while hot with a cleanroom cloth soaked in the pickling solution was attempted. The bellows were then repassivated by total immersion, rinsed three times in DI water, oven-dried at 110° C. for 1 hr, and CO₂ snow blasted. This procedure had no effect on the appearance of the stains, which were believed to be localized etch marks in the metal that occurred during initial processing of the parts when acid residues were drained from crevices in the part, and were subsequently concentrated and dried in the oven at 110° C. Such etch marks, while not impairing the performance of the bellows in the tool, are minimized by the method of the invention, wherein complete removal of the acid residues from the crevices and screw holes in the part is effected to suppress future recurrence of such stains.

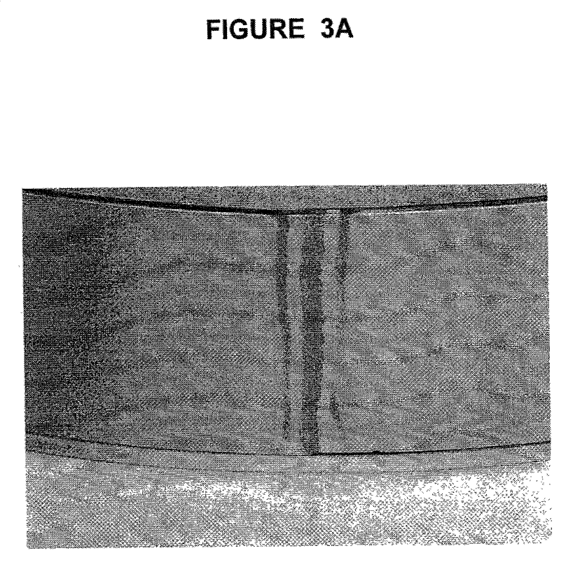

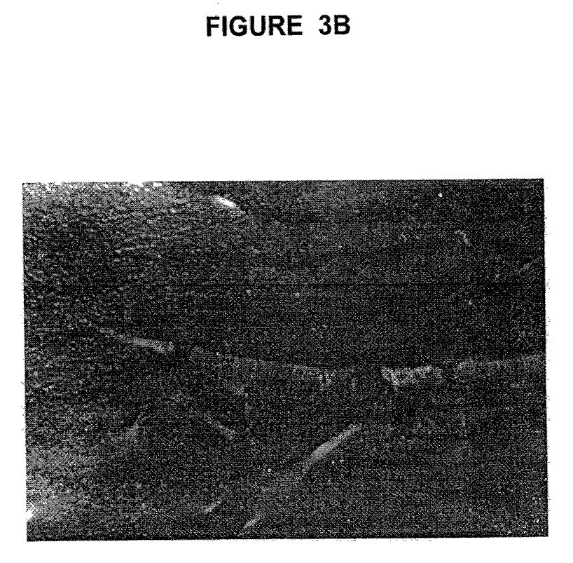

After exposure of the GVI outer shields to the pickling solution, differential etch marks were observed in the heat-affected zone of the butt weld joining the shield cylinder. An example is shown in FIG. 3A. This type of mark is normally caused by carbon contamination on the surface of the metal during welding, which cokes upon heating, allowing carbon impurities to dissolve into the surface of the metal. The presence of the impurities changes the grain structure of the metal, which is revealed on the surface as a variation in surface roughness when the metal is acid-etched. These etch marks however do not affect the performance of the stainless steel parts in the tool.

During final inspection of the BBSH packages, it was noted that extensive abrasion had occurred between the surface of the inner bag and the surfaces of the BBSH due to motion of the bag against the part when the bags were vacuum-sealed. An example of one of these abrasions sites on the inside surface of a nylon bag is shown in FIG. 3B. The white arrows in FIG. 3B indicate the abrasion marks. Since this is an obvious source of new particle contamination on the parts, all the parts were unpackaged, CO₂ snow blasted to remove any new plastic particle contamination, and then repackaged in the same materials but without evacuation. This eliminated the obvious bag abrasion problem described above, but does not preclude the possibility of further abrasion between the part and the bag during shipping and handling of the parts. This occurrence shows the desirability of packaging the parts for shipping, transport and storage in such manner as to suppress or preferably eliminate abrasive contacts that otherwise are a source of particle generation.

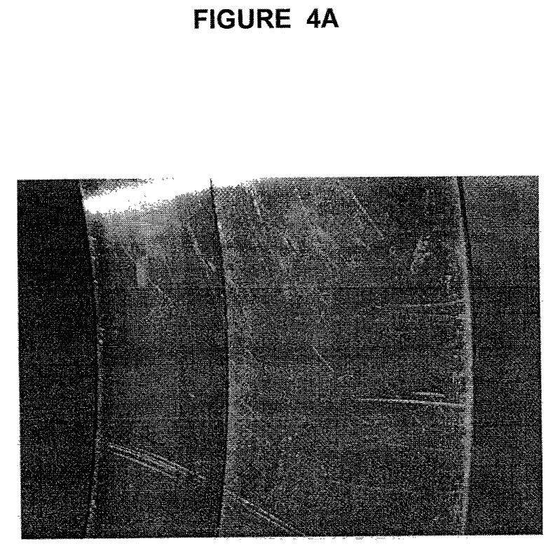

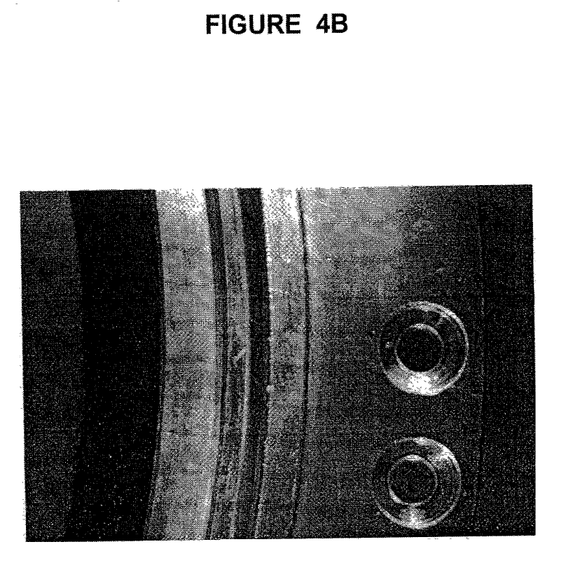

During initial inspection of the GVI bellows, significant gouges and scratches were noted on the O-ring sealing surface of both flanges on all four of these parts. In the majority of cases, damage was observed on more than one site per part. The white arrows in FIG. 4 indicate examples of such local damage, with FIG. 4A showing the GV1 bottom flange and FIG. 4B showing the GV1 top flange. These scratches are deep enough to prevent an O-ring from achieving a proper seal on these surfaces. The scratches on the flange sealing surfaces appear to be the result of rough handling. One may design and fabricate polymeric, e.g., polypropylene, covers to protect these sealing surfaces to thereby mitigate or preferably eliminate the effects of rough handling.

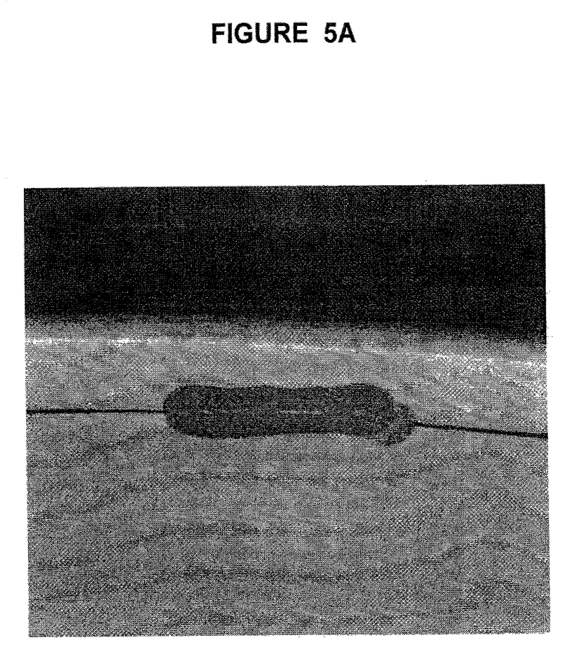

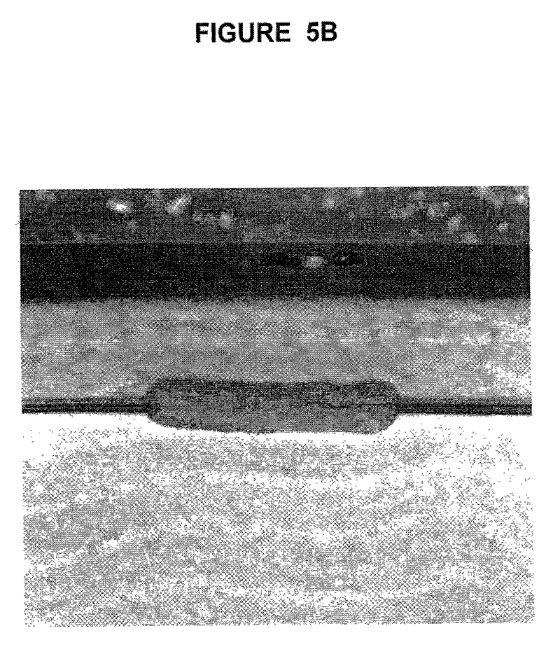

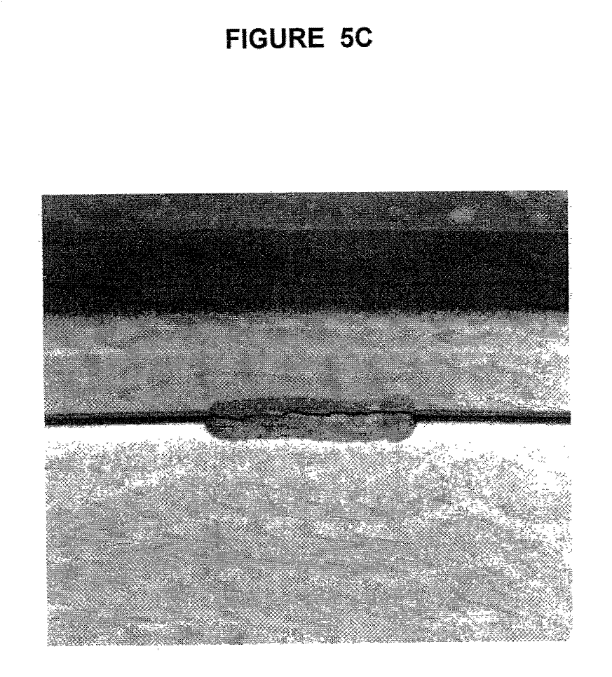

During initial inspection of the inner shields, cracks were observed in the spot welds holding the shield cylinder to the flange. Examples are shown in FIG. 5. FIG. 5A shows a good spot weld on a GV1 inner shield, FIG. 5B shows a ½ length cracked weld, and FIG. 5C shows a completely broken weld. These cracks were not the result of the chemical treatment but existed when the parts were received. A summary of the number of defective spot welds found on each of the four shields is presented in Table 7. These parts were not scribed with identification numbers. The part numbers indicated in the table were arbitrarily assigned to differentiate the four parts. Each shield had a total of 16 spot welds. Twenty-five percent of the total welds on all the parts were found to be defective. Most of the defective welds exhibited a hairline crack running ¼ to ½ the length of the weld. Only one weld was completely broken. No defects were observed in the continuous butt weld joining the inner shield cylinder. No weld defects were observed on any other parts in the kit.

TABLE 7
Inspection Summary on GV1 Inner Shield Spot Welds

| Part # | Number of Cracked Welds | Notes |
|---|---|---|
| 1 | 4 | One completely broken. |
| 2 | 12 | None completely broken. |
| 3 | 1 | Crack less than 1 mm in |
| | | length. |
| 4 | 0 | No defects observed in any |
| | | weld. |

The foregoing implicates the necessity of adopting good handling procedures for the parts in the semiconductor manufacturing facility after the parts are removed from packaging. A DI water soak performed in the semiconductor fabrication facility, preferably carried out with concurrent high frequency ultrasonic agitation, is advantageous for removing plastic particles that are generated and associated with the parts, by reason of such particles being scratched from the surface of the bag in which the parts are stored and shipped. If the parts are soaked in DI waters, then they need to be baked out. The time interval over which the parts are exposed to the semiconductor manufacturing plant's atmosphere during assembly is more than adequate to allow water adsorbed on the surface of the part to equilibrate with the ambient relative humidity. Therefore, the ambient exposure of the parts to the fab atmosphere is desirably minimized, so that subsequent pump-down rates are not limited by water desorption from these parts when the parts are assembled into the semiconductor manufacturing equipment in the fab. Another source of particle generation during handling of parts in the semiconductor fab is deposition of particles on the parts by abrasion when wiping the parts with IPA-soaked clean room wipes. Such wiping is used for removing large amounts of chemical and particle contamination on the parts acquired from tools, gloves, work surfaces, or the ambient environment during assembly and handling in the fab service areas, but can introduce chemical and particle contamination on very clean surfaces.

An effective approach for controlling contamination on the parts during final transportation, handling and assembly therefore may include the following steps: (a) CO₂ snow blasting of the parts at a cleaning facility after final oven drying; (b) immediate assembly of parts within a clean room environment; (c) CO₂ snow blasting the assembly to remove any accumulated chemical contamination and particle matter; (d) vacuum baking the assembly in the clean room environment; and (e) packaging the assembly while it is bolted down to a base plate in an evacuated hard container with a titanium getter. When the parts are required, the container of step (e) is vented, opened and the assembly is immediately installed in the tool.

The foregoing procedure provides a technique for: (i) packaging the parts in a manner that prevents abrasion between any part and the wall of the container, (ii) effective particle removal after assembly, (iii) effective removal of adsorbed water after assembly. The procedure thereby maintains the assembly in a clean and water-free state up to the point and time of use, and minimizes exposure of the parts to the humid fab environment.

While the invention has been shown and described with reference to specific features, aspects and embodiments herein, it will be appreciated that the invention is susceptible of a wide variety of other embodiments, features and implementations consistent with the disclosure herein, and the invention and claims hereafter set forth are therefore to be broadly construed and interpreted, within the spirit and scope of the foregoing disclosure.

What is claimed is:

1. A wet cleaning/passivation process for a contaminant-bearing passivatable part including a contaminant-bearing surface, said process comprising the steps of:
(a) contacting the contaminant-bearing part with an aqueous acid solution effective for pickling the contaminant-bearing surface of the part, with such contacting being conducted for sufficient time and at sufficient temperature to achieve pickling of the contaminant-bearing surface and produce a corresponding cleaned surface;
(b) contacting the cleaned surface of the part with a passivating aqueous solution, with such contacting being conducted for sufficient time and at sufficient temperature to passivate the cleaned surface; and
(c) CO₂ blasting the surface, to remove contaminant material from the surface.

2. The process of claim 1, wherein the aqueous acid solution of step (a) comprises hydrofluoric acid and nitric acid.

3. The process of claim 1, wherein the part after step (a) is rinsed in deionized water, to remove any fluoride ion present on said surface resulting from the pickling step.

4. The process of claim 1, wherein the passivating aqueous solution in step (b) comprises an acid.

5. The process of claim 1, further comprising rinsing the cleaned and passivated surface with deionized water to remove ionic residues and particle matter, after step (b).

6. The process of claim 5, wherein said rinsing step is conducted with ultrasonic cleaning of the surface.

7. The process of claim 1, further comprising drying the part prior to step (c).

8. The process of claim 1, wherein the CO₂ blasting comprises CO₂ ice blasting.

9. The process of claim 1, wherein the CO₂ blasting comprises CO₂ snow blasting.

10. The process of claim 2, wherein the amount of hydrofluoric acid in said solution is from about 0.2% to about 5% by weight, based on the total weight of the solution, and the amount of nitric acid in said solution is from about 5% to about 20% by weight, based on the total weight of the solution.

11. The process of claim 2, wherein the amount of hydrofluoric acid in said solution is about 1% by weight, based on the total weight of the solution, and the amount of nitric acid in said solution is about 7% by weight, based on the total weight of the solution.

12. The process of claim 2, wherein the weight ratio of HNO₃:HF in the aqueous acid solution is in a range of from 1 about to about 100.

13. The process of claim 2, wherein the weight ratio of HNO₃:HF in the aqueous acid solution is in a range of from about 5 to about 20.

14. The process of claim 1, wherein step (a) is carried out at a temperature in a range of from about 25° C. to about 80° C.

15. The process of claim 1, wherein step (a) is carried out at a temperature in a range of from about 30° C. to about 75° C.

16. The process of claim 1, wherein step (a) is carried out at a temperature in a range of from about 35° C. to about 65° C.

17. The process of claim 1, wherein the contaminant on the contaminant-bearing surface comprises a contaminant species selected from the group consisting of free iron, oxide scale, rust, grease, oil, carbonaceous and other residual chemical films, soil, particles, metal chips, and dirt.

18. The process of claim 1, wherein the contacting step (a) is carried out for a contacting time of 10 to 60 minutes.

19. The process of claim 1, wherein the passivating aqueous solution in step (b) comprises a passivating agent selected from the group consisting of nitric acid, citric acid, organosulfonic acids, silicon hydrides, germanium hydrides, tin hydrides, lead hydrides, potassium hydroxide, sodium hydroxide, copper sulfate, sodium chromate, and mixtures of two or more species thereof.

20. The process of claim 1, wherein the passivating aqueous solution in step (b) comprises nitric acid.

21. The process of claim 20, wherein the concentration of nitric acid in said passivating aqueous solution is in a range of from about 15% to about 50% by weight, based on the total weight of the passivating solution.

22. The process of claim 20, wherein the concentration of nitric acid in said passivating aqueous solution is in a range of from about 20% to about 40% by weight, based on the total weight of the passivating solution.

23. The process of claim 20, wherein the concentration of nitric acid in said passivating aqueous solution is in a range of from about 25% to about 30% by weight, based on the total weight of the passivating solution.

24. The process of claim 1, wherein the contacting step (b) is carried out at a temperature in a range of from about 25° C. to about 80° C.

25. The process of claim 1, wherein the contacting step (b) is carried out at a temperature in a range of from about 30° C. to about 75° C.

26. The process of claim 1, wherein the contacting step (b) is carried out at a temperature in a range of from about 35° C. to about 65° C.

27. The process of claim 1, wherein the contacting step (b) is carried out for a time in a range of from about 15 minutes to about 2 hours.

28. The process of claim 1, wherein the contaminant-bearing surface is formed of a material of construction selected from the group consisting of metal, ceramic, and cermet materials.

29. The process of claim 1, wherein the contaminant-bearing surface is formed of a material of construction comprising a metal.

30. The process of claim 29, wherein the metal comprises aluminum.

31. The process of claim 29, wherein the metal comprises steel.

32. The process of claim 29, wherein the metal comprises stainless steel.

33. The process of claim 29, wherein the metal comprises 316 L stainless steel.

34. The process of claim 29, wherein the metal comprises an austenitic steel.

35. The process of claim 1, further comprising drying of the passivated surface.

36. The process of claim 35, wherein the drying comprises air drying.

37. The process of claim 35, wherein the drying comprises alcohol drying.

38. The process of claim 35, wherein the drying comprises heating of the article in an oven.

39. The process of claim 1, wherein the contaminants on said contaminant-bearing surface include aluminum oxide and silicon dioxide.

40. The process of claim 1, wherein the contaminants on said contaminant-bearing surface include residue formed on the internal surfaces of semiconductor processing tools during patterned etching of aluminum metal from the surface of silicon wafers.

41. The process of claim 40, wherein the residue comprises Al₂O₃ and oxyfluoride analogs.

42. A process for cleaning and passivating a non-bellows stainless steel part, comprising the steps of:
(a) pickling the part in an aqueous pickling solution containing HF and HNO₃;
(b) soaking the part in a deionized water rinse bath;
(c) passivating the part by contacting it with an aqueous passivating solution;
(d) resoaking the part in a deionized water rinse bath;
(e) drying the part;
(f) CO₂ snow blasting the part.

43. The process of claim 42, wherein the part is dried in step (e) at elevated temperature.

44. The process of claim 42, wherein the part is dried in step (e) at elevated temperature, in an oven.

45. The process of claim 44, wherein the part is cooled to ambient temperature prior to step (f).

46. The process of claim 42, wherein the part is CO₂ snow blasted in a Class 100 clean room environment.

47. The process of claim 42, wherein the part after step (f) is packaged.

48. The process of claim 47, wherein the part is packaged in a polymeric heat-sealed packaging.

49. The process of claim 42, wherein the aqueous pickling solution in step (a) contains hydrofluoric acid in said solution in an amount of from about 0.2% to about 5% by weight, based on the total weight of the solution, and nitric acid in an amount of from about 5% to about 20% by weight, based on the total weight of the solution.

50. The process of claim 42, wherein the passivating aqueous solution in step (c) comprises nitric acid in an amount of from about 15% to about 50% by weight, based on the total weight of the aqueous passivating solution.

51. The process of claim 42, wherein steps (a) and (c) are conducted at elevated temperature.

52. A process for cleaning and passivating a semiconductor process tool bellows assembly including a bowl having an O-ring groove therein and an opposing flange to said bowl, said process comprising the steps of:
(a) polishing the O-ring groove on the bowl of the bellows, the outside of the bowl and the opposing flange at an outside edge thereof;
(b) pickling the bellows in an aqueous pickling solution including HF and HNO₃;
(c) rinsing the bellows in a deionized water bath;
(d) passivating the bellows in an aqueous passivating solution;
(e) rinsing the bellows in a deionized water bath; and
(f) CO₂ snow blasting the bellows.

53. The process of claim 52, wherein step (f) is conducted in a Class 100 clean room environment.

54. The process of claim 52, wherein the bellows is dried before CO₂ snow blasting step (f) is conducted.

55. The process of claim 54, wherein the bellows is dried at elevated temperature.

56. The process of claim 54, wherein the bellows is dried at elevated temperature, in an oven.

57. The process of claim 56, wherein the bellows is cooled to ambient temperature prior to step (f).

58. The process of claim 52, wherein the bellows after step (f) is packaged.

59. The process of claim 58, wherein the part is packaged in a polymeric heat-sealed packaging.

60. The process of claim 52, wherein the aqueous pickling solution in step (b) contains hydrofluoric acid in said solution in an amount of from about 0.2% to about 5% by weight, based on the total weight of the solution, and nitric acid in an amount of from about 5% to about 20% by weight, based on the total weight of the solution.

61. The process of claim 52, wherein the passivating aqueous solution in step (d) comprises nitric acid in an amount of from about 15% to about 50% by weight, based on the total weight of the aqueous passivating solution.

62. The process of claim 52, wherein steps (b) and (d) are conducted at elevated temperature.

63. A process of removing bead blasting residue from a stainless steel surface comprising same, said process comprising contacting the stainless steel surface comprising the bead blasting residue thereon with an aqueous pickling solution comprising hydrogen fluoride and nitric acid, in sufficient concentrations relative to each other to effect pickling removal of bead blasting residue from the surface, whereby the bead blasting residue on the surface is at least partially reduced by said contacting.

64. The process of claim 63, wherein the aqueous pickling solution contains hydrofluoric acid in an amount of from about 0.2% to about 5% by weight, based on the total weight of the solution, and nitric acid in an amount of from about 5% to about 20% by weight, based on the total weight of the solution.

65. The process of claim 63, wherein the surface is passivated after said contacting.

66. The process of claim 65, wherein the surface is passivated by contacting same with an aqueous passivating solution.

67. The process of claim 66, wherein the aqueous passivating solution comprises nitric acid.

68. The process of claim 67, wherein the nitric acid concentration in said aqueous passivating solution is from about 15% to about 50% by weight, based on the total weight of the aqueous passivating solution.

69. A method of increasing the operating life of a semiconductor processing tool between successive maintenance events, in which the semiconductor manufacturing tool comprises a stainless steel surface which during the operating life are contaminated with contaminant species deriving from a semiconductor process conducted by the semiconductor processing tool and/or ambient exposure to an ambient environment of the semiconductor processing tool, said method comprising conducting said maintenance events to include cleaning and passivation of the stainless steel surface initially presented as a contaminant-bearing surface, by steps including:
(a) contacting the surface with an aqueous acid solution effective for pickling the contaminant-bearing surface, with such contacting being conducted for sufficient time and at sufficient temperature to achieve pickling of the contaminant-bearing surface and produce a corresponding cleaned surface;
(b) contacting the cleaned surface with a passivating aqueous solution, with such contacting being conducted for sufficient time and at sufficient temperature to passivate the cleaned surface; and
(c) CO₂ blasting the surface, to remove contaminant material from the surface.

70. The method of claim 69, wherein the aqueous acid solution of step (a) comprises hydrofluoric acid and nitric acid.

71. The process of claim 69, wherein the part after step (a) is rinsed in deionized water, to remove any fluoride ion present on said surface resulting from the pickling step.

72. The process of claim 69, wherein the passivating aqueous solution in step (b) comprises an acid.

73. The process of claim 69, further comprising rinsing the cleaned and passivated surface with deionized water to remove ionic residues and particle matter, after step (b).

74. The process of claim 73, wherein said rinsing step is conducted with ultrasonic cleaning of the surface.

75. The process of claim 69, further comprising drying the part prior to step (c).

76. The process of claim 69, wherein the CO₂ blasting comprises CO₂ ice blasting.

77. The process of claim 69, wherein the CO₂ blasting comprises CO₂ snow blasting.

78. The process of claim 70, wherein the amount of hydrofluoric acid in said solution is from about 0.2% to about 5% by weight, based on the total weight of the solution, and the amount of nitric acid in said solution is from about 5% to about 20% by weight, based on the total weight of the solution.

79. The process of claim 70, wherein the amount of hydrofluoric acid in said solution is about 1% by weight, based on the total weight of the solution, and the amount of nitric acid in said solution is about 7% by weight, based on the total weight of the solution.

80. The process of claim 70, wherein the weight ratio of HNO₃:HIF in the aqueous acid solution is in a range of from 1 about to about 100.

81. The process of claim 70, wherein the weight ratio of HNO₃:HF in the aqueous acid solution is in a range of from about 5 to about 20.

82. The process of claim 69, wherein step (a) is carried out at a temperature in a range of from about 25° C. to about 80° C.

83. The process of claim 69, wherein step (a) is carried out at a temperature in a range of from about 30° C. to about 75° C.

84. The process of claim 69, wherein step (a) is carried out at a temperature in a range of from about 35° C. to about 65° C.

85. The process of claim 69, wherein the contaminant on the contaminant-bearing surface comprises a contaminant species selected from the group consisting of free iron, oxide scale, rust, grease, oil, carbonaceous and other residual chemical films, soil, particles, metal chips, and dirt.

86. The process of claim 69, wherein the contacting step (a) is carried out for a contacting time of 10 to 60 minutes.

87. The process of claim 69, wherein the passivating aqueous solution in step (b) comprises a passivating agent selected from the group consisting of nitric acid, citric acid, organosulfonic acids, silicon hydrides, germanium hydrides, tin hydrides, lead hydrides, potassium hydroxide, sodium hydroxide, copper sulfate, sodium chromate, and mixtures of two or more species thereof.

88. The process of claim 69, wherein the passivating aqueous solution in step (b) comprises nitric acid.

89. The process of claim 88, wherein the concentration of nitric acid in said passivating aqueous solution is in a range of from about 15% to about 50% by weight, based on the total weight of the passivating solution.

90. The process of claim 88, wherein the concentration of nitric acid in said passivating aqueous solution is in a range of from about 20% to about 40% by weight, based on the total weight of the passivating solution.

91. The process of claim 88, wherein the concentration of nitric acid in said passivating aqueous solution is in a range of from about 25% to about 30% by weight, based on the total weight of the passivating solution.

92. The process of claim 69, wherein the contacting step (b) is carried out at a temperature in a range of from about 25° C. to about 80° C.

93. The process of claim 69, wherein the contacting step (b) is carried out at a temperature in a range of from about 30° C. to about 75° C.

94. The process of claim 69, wherein the contacting step (b) is carried out at a temperature in a range of from about 35° C. to about 65° C.

95. The process of claim 69, wherein the contacting step (b) is carried out for a time in a range of from about 15 minutes to about 2 hours.

96. A method of determining amenability of a stainless steel surface of a semiconductor manufacturing tool to wet cleaning and passivation treatment, wherein the wet cleaning and passivation treatment includes exposure of the stainless steel surface to an aqueous acid solution, said method comprising contacting the surface with an aqueous acid solution of at least the same strength as that involved in said wet cleaning and passivation treatment, and determining whether insoluble powder is released from the surface into the aqueous acid solution, evidencing intergranular corrosive attack of the surface, and contraindicating the surface as amenable to said wet cleaning and passivation treatment.

97. A method of controlling contamination of semiconductor processing tool parts forming a component assembly of a semiconductor processing tool, prior to incorporation of the parts into a tool in a semiconductor processing facility, said method comprising the steps of: (a) CO₂ snow blasting of the parts; (b) assembling the parts upon completion of step (a), in a clean room environment; (c) CO₂ snow blasting the assembly to remove any accumulated chemical contamination and particle matter; (d) vacuum baking the assembly in the clean room environment; (e) securing the assembly to a fixture member in an evacuated hard container; (f) packaging the assembly with a getter; and (g) installing the assembly in the tool in the semiconductor processing facility upon removal of the assembly from the evacuated hard container.

98. The method of claim 97, wherein the getter comprises a titanium getter.

99. The method of claim 97, wherein the assembly comprises an etch tool assembly.

100. A process of operating a semiconductor processing facility wherein parts comprising stainless steel surfaces are periodically cleaned to renew the parts for reuse in the facility, and cleaning includes treatment that increases surface roughness, wherein the process comprises (a) marking each part with identification indicia, (b) tracking surface roughness and number of cleaning cycles with reference to said identification indicia to determine when the parts have reached or will reach a predetermined maximum roughness limit, and (c) polishing surfaces of the parts before their surfaces exceed the predetermined maximum roughness limit, to restore lower roughness to such surfaces, for reuse of the parts in said semiconductor processing facility.
